(19) United States
(12) Patent Application Publication
(10) Pub. No.: US 2025/0307118 A1
(43) Pub. Date: Oct. 2, 2025

(54) DEBUGGING SCRIPTING LANGUAGE PROGRAMS EXECUTED USING MULTIPLE EXECUTION ENGINES

(71) Applicant: Goldman Sachs & Co. LLC, New York, NY (US)

(72) Inventors: Zachary Michael Fernandez, Southlake, TX (US); Ian Martin Oversby, Sevenoaks, Kent (GB); Cosmin Vladianu, London (GB); Michal Dorko, London (GB)

(21) Appl. No.: 19/093,850

(22) Filed: Mar. 28, 2025

Related U.S. Application Data
(60) Provisional application No. 63/572,107, filed on Mar. 29, 2024.
(60) Provisional application No. 63/671,686, filed on Jul. 15, 2024.

(51) Int. Cl. G06F 11/362

(52) U.S. Cl. CPC G06F 11/3656

(57) ABSTRACT

A system configures a debugger interface for interacting with a plurality of debugging processes that are configured to debug scripting language programs. Each debugging process runs on an execution engine. A scripting language program can be debugged across the execution engines. The system receives debug commands, which are sent to a first execution engine that debugs a first section of a scripting language program. Debug information from the first execution engine describing debugging of the first section is sent to the debugger interface for display. The system receives debug instructions from the first execution engine to debug a second section of the scripting language program, and the system switches debugging of the scripting language program to a second execution engine. The system may continue to switch debugging between execution engines based on the receipt of new debug instructions until the entirety of the scripting language program has been debugged.

### CROSS REFERENCE TO RELATED APPLICATIONS

This application claims the benefit of U.S. Provisional Application No. 63/572,107, filed Mar. 29, 2024, which is incorporated by reference herein, and U.S. Provisional Application No. 63/671,686, filed Jul. 15, 2024, which is incorporated by reference herein.

### BACKGROUND

### 1. Field of Disclosure

The disclosure generally relates to debugging of code and more specifically to executing and debugging a scripting language program using multiple execution engines.

### 2. Description of Related Art

Scripting languages are often used as high-level programming languages used for specific purposes, for example, for specifying domain specific instructions such as instructions for performing operating system tasks, for specifying behavior of user interfaces, for rapid prototyping, and so on. Scripting languages are often implemented using an interpreter. Interpreter based languages are often computationally slow. As a result, the performance of a scripting language may be improved by changing the implementation of the execution engine for processing the language. However, changing the execution engine can be challenging as there is a significant amount of legacy code that is optimized for the original execution engine.

### SUMMARY

A programming language (referred to as Slang) allows scripting. The scripting may be for specific purposes, for example, for database applications, for writing graphical user interfaces (GUI), for managing operating systems tasks, or for other purposes. The programming language has two implementations of execution engines for processing programs written in the programming language: (1) an AST (abstract syntax tree) based interpreter and (2) a bytecode-based interpreter. SlangVM is the bytecode-based interpreter for Slang. Execution may seamlessly switch between the two interpreters. This allows gradual migration from the AST version to the bytecode version. The system allows users to debug through scripting code independent of whether any particular section of scripting code is executed by the bytecode-based interpreter or by the AST-based interpreter. Accordingly, the system uses a mechanism that shares debugger state between the two disparate runtimes and their respective debuggers.

According to an embodiment, a system configures a debugger interface for interacting with a plurality of debugging processes that are configured to debug scripting language programs. Each debugging process runs on an execution engine (also referred to as a runtime or runtime engine herein). A scripting language program can be debugged across the execution engines running the plurality of debugging processes. The system receives debug commands via the debugger interface, which the debugger interface sends to a first execution engine that debugs a first section of the scripting language program. In turn, the first execution engine sends debug information describing debugging of the first section to the debugger interface for display.

The system receives debug instructions from the first execution engine to debug a second section of the scripting language program, and the system switches debugging of the scripting language program to a second execution engine of the plurality of execution engines. The system receives debug information from the second execution engine. The system may continue to switch debugging of the scripting language program between execution engines based on the receipt of new debug instructions until the entirety of the scripting language program has been debugged, an error in debugging occurs, the debugger interface receives a command to stop debugging, etc.

### BRIEF DESCRIPTION OF THE DRAWINGS

FIG. 1 illustrates an example system environment for a debugger interface, in accordance with one or more embodiments.

FIG. 2 illustrates a block diagram of a debugging system, in accordance with one or more embodiments.

FIGS. 3A-B illustrates interaction diagrams showing interactions between a debugger interface module, execution engines, and debugger modules, in accordance with one or more embodiments.

FIG. 4 is a flowchart illustrating a method of switching debugging from a first debugging process to a second debugging process, in accordance with one or more embodiments.

FIG. 5 is a high-level block diagram of a computer for implementing different entities illustrated in FIG. 1, in accordance with one or more embodiments.

### DETAILED DESCRIPTION

According to an embodiment, the system allows debugging scripting language programs that are executed using multiple execution engines. The system allows the user to debug through the scripting language program, for example, by stepping through the code, setting break points, and so on. A scripting language program written using a scripting language may include sections that are processed by different execution engines. The system uses a debugging process for each execution engine. For example, the system may run two debugging processes, a first debugging process D1 to process a first section P1 of the scripting language program executed by a first execution engine E1 and a second debugging process D2 to process a second section P2 of the scripting language program executed by a second execution engine E2. The system provides a common debugger interface for interacting with both the debugging processes. The common debugger interface allows a user to debug through various sections of the scripting language program seamlessly, regardless of which of the execution engines is being used for executing any particular section of the scripting language program. The debugger interface may be a graphical user interface that is displayed via a client device or may be an application programming interface (API) that is invoked by executable instructions for interacting with the debugging processes.

The debugger interface allows users to debug the scripting language program no matter which of the execution engines is processing a respective section of the scripting language code. The debugger interface receives a debug command and displays a status of execution of the scripting language program responsive to receiving the debug command, regardless of whether the status of execution is received from the first debugging process or from the second debugging process. For example, a scripting language program may include a first section that is executed using the AST interpreter and a second section that is executed using the bytecode interpreter. The AST debugging process interacts with the AST interpreter while the user is debugging the first section of the scripting language program, and the bytecode debugging process interacts with the bytecode interpreter when the user is debugging the second section of the scripting language program. The debugger interface receives the status of execution of the scripting language program from the AST debugging process when the user is debugging the first section of the scripting language program and from the bytecode debugging process when the user is debugging the second section of the scripting language program.

The debugger interface receives debug commands via interactions by a user with interactive elements presented via the debugger interface. Debug commands may include, for example, execute a next instruction, set a breakpoint at a specific line of code, step into a current line of code, step out of a function, and so on. The debugger interface also displays information describing the execution of the scripting language program, for example, a current line being executed, variables of the scripting language program, values of the variables when the current line is being executed, and the like. The variable values may change as the scripting language program execution continues based on the debug commands.

Furthermore, the execution of the scripting language program via the debugger may transparently and seamlessly transition from the first execution engine to the second execution engine. For example, as the user steps through the scripting language program, the execution of the instructions of the scripting language program may transition from an AST- based execution engine to a bytecode-based execution engine, or it may transition from a bytecode-based execution engine to an AST-based execution engine.

The Figures (FIG.) and the following description relate to various embodiments by way of illustration only. It should be noted that from the following discussion, alternative embodiments of the structures and methods disclosed herein will be readily recognized as viable alternatives that may be employed without departing from the principles discussed herein. Reference will now be made in detail to several embodiments, examples of which are illustrated in the accompanying figures. It is noted that wherever practicable similar or like reference numbers may be used in the figures and may indicate similar or like functionality.

### System Overview

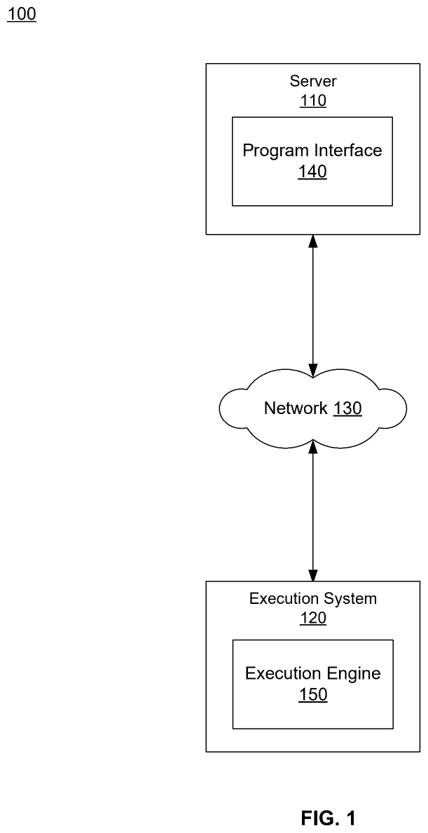

FIG. 1 is a block diagram of an overall system environment 100 illustrating a program interface 140, according to an embodiment. As shown in FIG. 1, the overall system environment 100 includes the program interface 140, a server 110, an execution system 120 comprising an execution engine 150, and a network 130. Other embodiments may use more or fewer or different components than those illustrated in FIG. 1. Functions of various modules and systems described herein can be implemented by other modules and/or systems than those described herein.

The overall system environment includes a server 110 that supports the program interface 140. The server 110 may be a computing device that provides resources, data, services, or programs to other computing devices over the network 130. In some embodiments, the server 110 operates at a personal or mobile computing device, such as a smartphone, a tablet, a laptop computer, or desktop computer. In some embodiments, the server 110 executes a client application at a computing device, where the client application uses an application programming interface (API) to communicate with the execution system 120. In one example, the server 110 may cause a webpage to display the program interface 140 such that a user can interact with the program interface 140 to debug scripting language programs.

The program interface 140 provides user interfaces that allow users to debug scripting language programs. A scripting language program is a set of computer/software code that represents instructions that a server 110 can interpret and execute. For instance, a scripting language program may be a written set of rules and procedures that guides the computer to perform certain tasks like calculations, data processing, or automated reasoning tasks. A scripting language program may sometimes include problems (or “bugs” or “defects”) that prevent the server 110 from being able to fully execute the scripting language program. The program interface 140 is configured to receive interactions that represent commands to debug a scripting language program using the execution engine 150. The commands may also represent instructions to start debugging, stop debugging, debug a specific section of the scripting language program, and the like.

The server 110 communicates commands input via the program interface 140 with the execution system 120 via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 may also use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

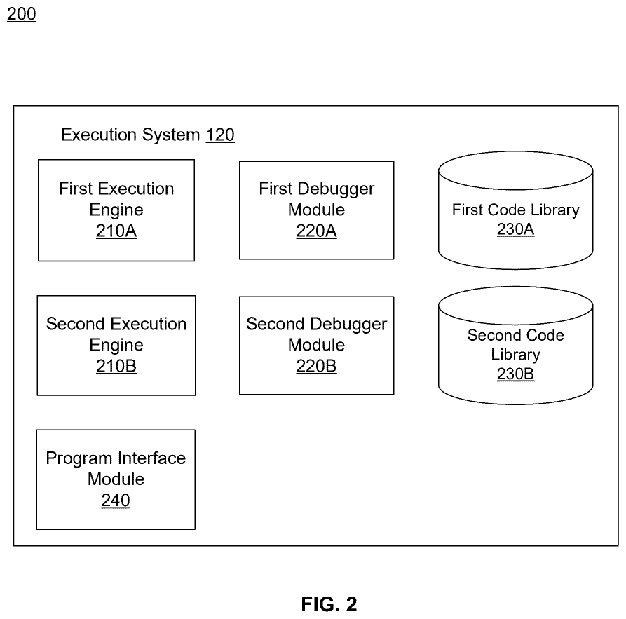

To identify, isolate, and fix defects in a scripting language program, the server 110 can send commands input at the program interface 140 that instruct an execution engine 150 to perform a debugging process on the scripting language program. A debugging process may identify one or more defects in the scripting language program, isolate the defect within the scripting language program to understand the circumstances under which the defect occurs, diagnose the line or condition within the scripting language program that includes the defect, and correct the scripting language program to remove the defect. Debugging may be specific to a type of language of the scripting language program, so the execution engine 150 may be configured to debug for a specific type of language. In some embodiments, the scripting language program may include sections written in different languages, thus necessitating the use of multiple execution engines 150 to debug the scripting language program, as is described further in relation to FIG. 2.

The execution system 120 communicates with the server 110 to debug scripting language programs. The execution system 120 receives commands from the server 110 and inputs the commends to an execution engine 150 (also referred to as an “interpreter” herein) that executes and debugs scripting language programs. The execution engine 150 controls an execution flow of scripting language program selected via the program interface 140 and communicates with the server 110 such that a user can stop, start, and step through the scripting language program executing at the execution engine 150. The execution engine 150 can implement breakpoints, single-steps, variable inspection, and other features during debugging of a scripting language program and communicate debug information captured at the breakpoint to the server 110 for display via the program interface 140.

FIG. 2 illustrates a block diagram of the execution system 120, in accordance with one or more embodiments. The execution system 120 includes a first execution engine 210A, first debugger module 220A, first code library 230A, second execution engine 210B, second debugger module 220B, second code library 230B, and a program interface module 240. Though only two debugging processes are described in relation to the program interface module 240, in some embodiments, the program interface module 240 implements additional execution engines 210, debugger modules 220, and code libraries 230 to debug other sections of a scripting language program.

The program interface module 240 sends instructions that configure the program interface 140 for receiving scripting language programs that will be executed via a first execution engine 210A and a second execution engine 210B. According to an embodiment, the first execution engine 210A is configured to process some sections of scripting language programs using an AST based interpreter, and the second execution engine 210B is configured to process other sections of scripting language programs using a byte code interpreter. The program interface module 240 starts the first execution engine 210A and second execution engine 210B and receives, via the program interface 140, a scripting language program that includes a first set of sections and a second set of sections of the scripting programming language. The program interface module 240 starts execution of the scripting language program using the first execution engine 210A. During execution of the scripting language program using the first execution engine 210A, the program interface module 240 switches execution of the scripting language program to the second execution engine 210B. The program interface module 240 may switch execution of the scripting language program back and forth between the first execution engine 210A and second execution engine 210B and output information received from the first execution engine 210A and second execution engine 210B to the program interface 140 for display.

For example, in some embodiments, the program interface module 240 starts the first execution engine 210A and the second execution engine 210B. The program interface module 240 starts execution of a scripting language program using the first execution engine 210A. During execution of the scripting language program using the first execution engine 210A, the program interface module 240 switches execution of the scripting language program to the second execution engine 210B. The program interface module 240 switches execution of the scripting language program back to the first execution engine 210A. The program interface module 240 receives a first set of one or more debug commands for debugging a first section of the scripting language program and sends a first set of debug information obtained from the first execution engine 210A to the program interface 140 (also referred to as a debugger interface). The program interface module 240 receives, via the program interface 140, debug instructions to continue debugging into a second section of the scripting language program and switches debugging of the scripting language program from the first execution engine 210A to the second execution engine 210B. The program interface module 240 sends a second set of debug information obtained from the second execution engine 210B to the program interface 140.

The program interface module 240 (also referred to as a debugger interface module 240) sends instructions that configure the program interface 140 for interacting with a first debugging process performed by the first debugger module 220A and a second debugging process performed by the second debugger module 220B. The first debugging process is configured to debug scripting language programs using the first execution engine 210A, and the second debugging process is configured to debug scripting language programs using the second execution engine 210B.

The program interface module 240 receives a scripting language program from the program interface 140. In some embodiments, the program interface module 240 stores the scripting language program locally such that the program interface 140 can send commands to debug the scripting language program through sending an identifier of the scripting language program, rather than the entire scripting language program itself. The scripting language program includes a first section and a second section. The first section is configured to be executed using the first execution engine 210A, and the second section is configured to be executed using the second execution engine 210B. The first section may be written in a first code language described in the first code library 230A, which the first debugger module 220A may access for performing a first debugging process that the first execution engine 210A is configured for. Similarly, the second section may be written in a second code language described in the second code library 230B, which the second debugger module 220B may access for performing a second debugging process that the second execution engine 210A is configured for.

For example, the first section may require an AST-based interpreter for debugging, while the second section may require a bytecode-based interpreter for debugging. Since the sections cannot be debugged using the same interpreter, the program interface module 240 causes the first section to be debugged by the first execution engine 210A, which may be an AST-based interpreter, and the second section to be debugged by the second execution engine 210B, which may be a bytecode interpreter.

The program interface module 240 may receive commands from the program interface 140 for debugging actions to be performed on the first section of the scripting language program, such as, for example, to run a sub-section of the first section, stop at a specific line within the first section, etc. The program interface module 240 communicates the commands to the first debugger module 220A, which causes corresponding debugging actions to occur at the first execution engine 210A for the first debugging process. The program interface module 240 receives debug information from the first debugger module 220A and transmits the debug information for display at the program interface 140. The debug information may describe a current state of the first debugging process running at the first execution engine 210A, information identifying a line of the scripting language program that is currently executing, one or more variables of the scripting language program, values of one or more variables when the line of the scripting language program that is currently executing, etc.

The program interface module 240 may receive, from the first debugging process via the first debugger module 220A, debug instructions to continue debugging into the second section of the scripting program language. For example, the first debugging process may have reached the end of the first section or a subsection of the first section that calls upon the second section (or a subsection thereof) to run in order for debugging to continue. The program interface module 240 switches debugging of the scripting language program from the first debugging process facilitated with the first debugger module 220A to the second debugging process, which is facilitated by the second debugger module 220B using the second execution engine 210B. The program interface module 240 may receive debug information from the second debug process via the second debugger module 220B and transmit the debug information to the program interface 140 for display. The program interface module 240 may also implement debugging actions in the second debugging process based on debug commands received from the program interface 140.

The program interface module 240 may move debugging of the scripting language program back and forth between the first and second debugging process numerous times, as instructed via debug commands or based on debug instructions received via either debugging process. For example, in some embodiments, in response to switching debugging of the scripting language program to the second debugging process, the program interface module 240 receives a third set of debug instructions from the program interface 140. The third set of debug instructions may indicate to debug the first section of the scripting language program using the first debugging process, and the program interface module 240 may switch debugging of the scripting language program from the second debugging process back to the first debugging process.

The program interface module 240 performs state synchronizations between the first and second debugging processes. The state synchronization ensures that changes to the state of the code of the scripting language program caused by the first debugging process are propagated to the second debugging process and changes to state by the second debugging process are propagated to the first debugging process. For example, if the current line number of the code being debugged using the first debugging process is incremented, the program interface module 240 instructs the second debugger module 220B to update the current line number of the code being debugged for the second debugging process. The current line number being debugged is tracked by both debugger modules 220 even if the corresponding execution engine 210 does not have the instructions to execute the code at that line number. For example, the second debugger modules 220B may track the line number of code that is executed by the first debugger module 220A, even if the second section does not correspond to that line. Similarly, the first debugger module 220A may track the line number of a code being debugged by the second debugger module 220B, even if the first section does not correspond to that line of code.

In some embodiments, the program interface module 240 may perform state synchronization between the first and second debugging processes. The program interface module 240 may use a publish subscribe mechanism so that each of the first debugger module 220A and the second debugger module 220B publishes and subscribes to the other debugger module's outputs. Thus, when a respective debugging process is processing the scripting language program, the associated debugger module 220 publishes details of the corresponding debugger execution at the corresponding execution engine 210. For example, if the first debugger module 220A is executing the first section on the first execution engine 210A, the program interface module 240 receives the details of execution, for example, which line of code was executed and causes the program interface 140 to display the details. Similarly, if the second debugger module 220B is executing the second section at the second execution engine 210B, the program interface module 240 receives the details of execution, including the current line number of the scripting language program that is being executed on the second execution engine 210B.

In some embodiments, the program interface module 240 uses a publish subscribe mechanism to broadcast a first status of execution of the first debugging process from the first debugger module 220A to the second debugger module 220B and to broadcast a second status of execution of the second debugging process from the second debugger module 220B to the first debugger module 220A. The status of execution may include status of execution information identifying a line of the scripting language program that is currently executing. In some embodiments, the program interface module 240 configures the first debugger module 220A to send a status of execution of the first debugging process, which the program interface module 240 causes to be published for display via the program interface 140 and sends the status of execution of the scripting language program of the first debugging process to the second debugger module 220B. The program interface module 240 may configure the second debugger module 220B to also cause a status of execution of the second debugging process to be sent for publication and send the status to the first debugger module 220A. In some embodiments, the program interface module 240 may receive a debug instruction and cause the program interface 140 to display a status of execution of the scripting language program in response. The program interface module 240 may do so regardless of whether the status of execution is received from the first debugger module 220A or the second debugger module 220B.

In some embodiments, the execution system 120 is configured to debug scripting language programs that include sections written in the scripting language Slang. Slang allows users and developers to perform rapid prototyping and deploy their changes to production very quickly. Slang scripting language programs are stored as binary objects in a database, which may be at the execution system 120. Slang has a runtime, such as the AST-based interpreter described above, which is implemented as a tree-walker interpreter. For this interpreter, Slang code is initially parsed into an AST, which is then directly executed, and each node in the tree includes instructions to evaluate itself and has pointers to its children nodes.

Slang is associated with a second runtime, SlangVM, which is a virtual machine. SlangVM operates on bytecode, which is represented as an array of bytes. Bytes are laid out in memory as a series of instructions followed by zero or more arguments. Each opcode of the bytecode handles zero or more arguments. SlangVM supports a few datatypes natively, such as integral types and opcodes, various addresses and jump offsets, and constant indices. Any other datatypes are stored in a constant pool and referred to by a constant index.

According to an embodiment, SlangVM is implemented as a stack-based bytecode interpreter and shares a few aspects of implementation with the AST-based interpreter. In particular, the bytecode-based interpreter shares a type system, variable representation, and Slang stack frame representation with the AST-based interpreter. The compilation with the bytecode-based interpreter is an additive step to the AST parsing step. The bytecode-based interpreter retains the current AST and does not discard or destroy the current AST during bytecode execution or debugging. This allows the execution system 120 to gracefully fall back from the bytecode-based interpreter to the AST-based interpreter if the bytecode-based interpreter is unable to compile and evaluate expressions and code during debugging. When execution at the AST-based interpreter is complete, debugging returns to the bytecode-based interpreter.

The bytecode-based interpreter is faster than the AST-based interpreter, with 25% improvement in processing efficiency. By using a just-in-time (JIT) compilation of bytecode into native assembly, execution using the bytecode interpreter rather than only the AST-based interpreter results in more than 10× or more increase in speed, thus reducing compute hours by up to hundreds of millions of compute hours per week. Use of the combination of the bytecode-based interpreter and AST-based interpreter can reduce an organization's footprint by hundreds of millions of compute hours per week.

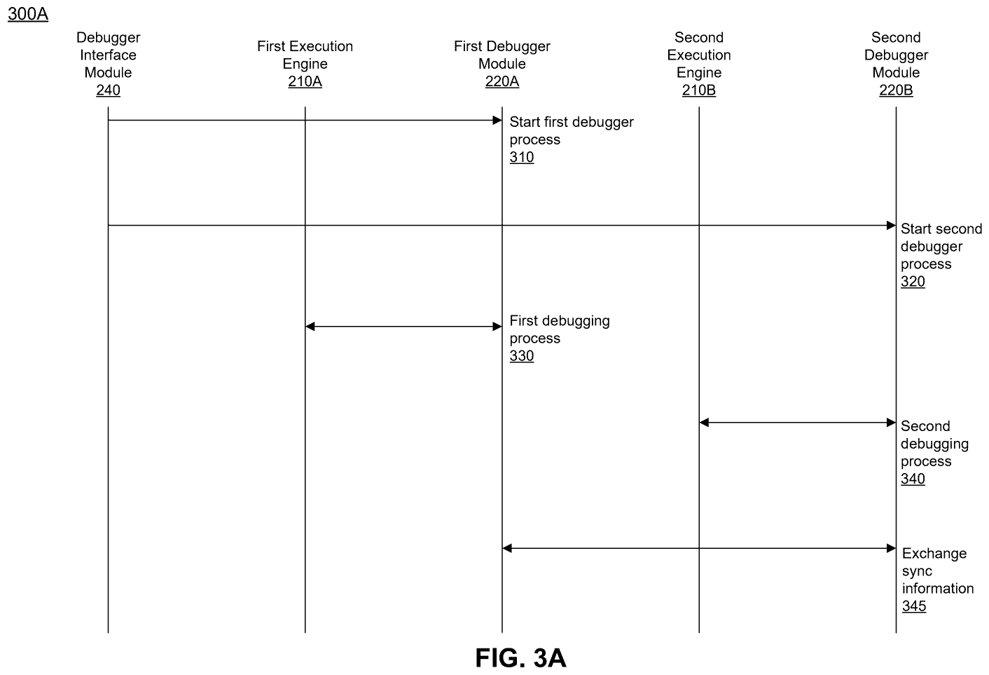

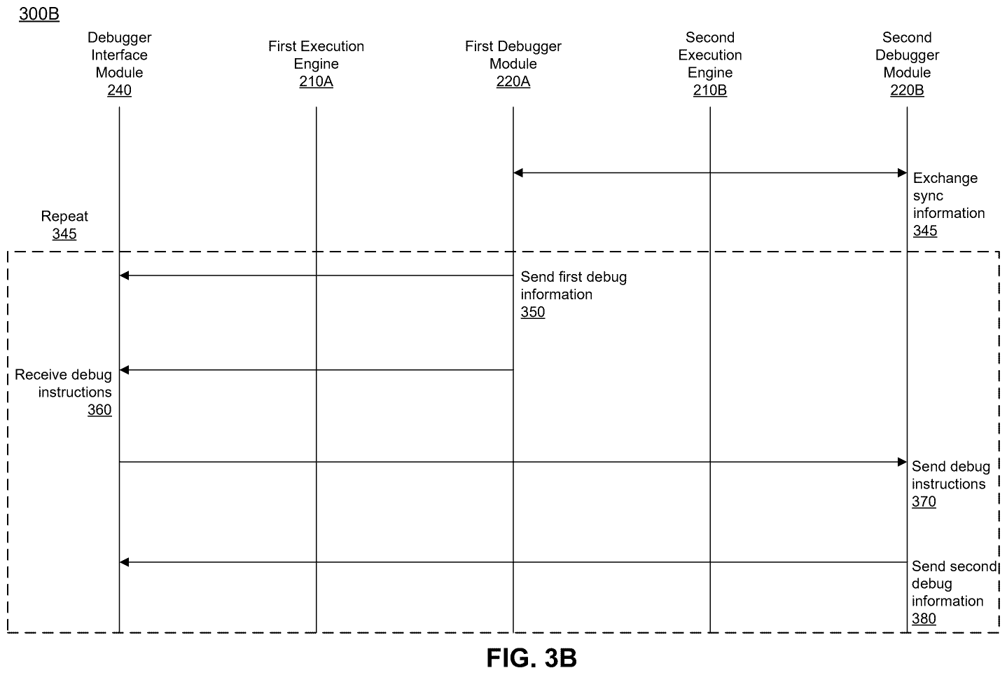

FIGS. 3A-B illustrate interaction diagrams showing interactions between a debugger interface module, execution engines, and debugger modules, in accordance with one or more embodiments. In some embodiments, additional or alternative interactions to those shown in FIGS. 3-B may occur.

In FIG. 3A, the program interface module 240 begins debugging a scripting language program. The program interface module 240 may break the scripting language program into a first section and a second section, where each section includes code written in a different scripting language than the other section. The program interface module 240 causes a first debugging process for the first section to start 310 at the first debugger module 220A and causes a second debugging process for the second section to start 320 at the second debugger module 220B. The program interface module 240 may also send debug commands to the first debugger module 220A and the second debugger module 220B. The first debugger module 220A interacts with the first execution engine 210A for the first debugging process 330 and may send debug information about the first debugging process 330 to the program interface module 240 to display at a user device. The second debugger module 220B interacts with the second execution engine 210B for the second debugging process 340 and may send debug information about the second debugging process 340 to the program interface module 240 to display at a user device. The first debugger module 220A and second debugger module 220B exchange 345 sync (e.g., synchronization) information describing each respective process, such that the state of the scripting language program being debugged is accurately reflected at each of the first execution engine 210A and second execution engine 210B.

In FIG. 3B, the components may repeat 345 the interactions that occur after the exchange 345 of sync information. In particular, the first debugger module 220A sends 350 first debug information to the debugger interface, which the program interface module 240 may cause a user device to display for an external user to see what is happening in the first debugging process 330. The program interface module 240 receives 360 debug instructions from the first debugger module 220A. The debug instructions indicate to continue debugging into the second section of the scripting language program. The program interface module 240 sends 370 the debug instructions to the second debugger module 220B, thus switching the debugging of the scripting language program from the first debugging process 330 to the second debugging process 340. Though the second debugging process 340 may have begun before receipt of the debug instructions by the second debugger module 220B, the second debugging process 340 may include keeping the second execution engine 210B in sync with any changes made for the scripting language program based on debugging done in the first debugging process 330. Thus, the second debugger module 220B may interact with the second execution engine 210B to debug the second section of the scripting language without needing to request information about debugging that occurred at the first execution engine 210A. The second debugger module 220B sends second debug information to the program interface module 240 for display at a user device. In some embodiments, the second debugger module 220B may send new debug instructions to the program interface module 240 that causes debugging to switch back to the first debugging process 330.

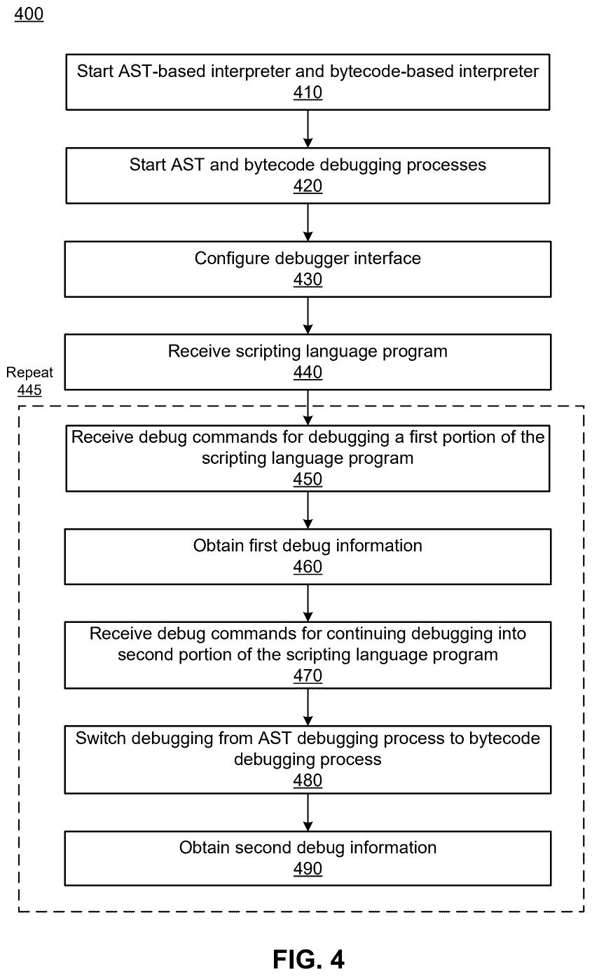

FIG. 4 is a flowchart illustrating a method 400 of switching debugging from a first debugging process to a second debugging process, in accordance with one or more embodiments. In the example embodiments, the first execution engine 210A and second execution engine 210B are an AST-based interpreter and bytecode-based interpreter, respectively. In other embodiments, the execution engines may be other interpreters configured for debugging code scripting languages other than AST and bytecode and may include additional or alternative steps to those shown in FIG. 4.

The program interface module 240 starts 410 the AST-based interpreter and bytecode-based interpreter. The program interface module 240 starts 420 an AST debugging process configured to debug scripting language programs executed using the AST-based interpreter and a bytecode debugging process configured to debug scripting language programs using the bytecode-based interpreter. The program interface module 240 configures 430 the program interface 140 for interacting with the AST debugging process and the bytecode debugging process. The program interface 140 may be a graphical user interface or an application programming interface presented at a user device. The program interface module 240 receives 440 a scripting language program for debugging, where the scripting language program includes a first section compiled into an abstract syntax tree and a second section compiled into bytecode.

The program interface module 240 receives 450, via the program interface 140, a first set of one or more debug commands for debugging the first section of the scripting language program using the AST debugging process. The program interface module 240 obtains 460 a first set of debug information obtained from the AST debugging process and sends the first set of debug information to the program interface 140, such that the program interface 140 displays at least a section of the first debug information. The program interface module 240 receives 470, entered by an external user via the program interface 140, debug commands to continue debugging into the second section of the scripting language program. In some embodiments, the program interface module 240 receives debug instructions from the AST-based interpreter (e.g., because debugging needs to switch from the first section to the second section to continue) to switch from the AST debugging process to the bytecode debugging process.

The program interface module 240 switches 480 debugging of the scripting language program from the AST debugging process to the bytecode debugging process. The program interface module 240 obtains 490 second debug information from the bytecode debugging process and may cause the program interface 140 to display the second debug information at a user device. In some embodiments, the program interface module 240 may repeat 445 a version of steps 450-490 where the debugging of the scripting program is moved back to the AST debugging process from the bytecode debugging process. The program interface module 240 may repeat 445 the steps alternating back and forth between the AST debugging process and bytecode debugging process for debugging the scripting language program. In some embodiments, the program interface module 240 may also move debugging to other interpreters that are configured to debug for other scripting languages.

### Computer Architecture

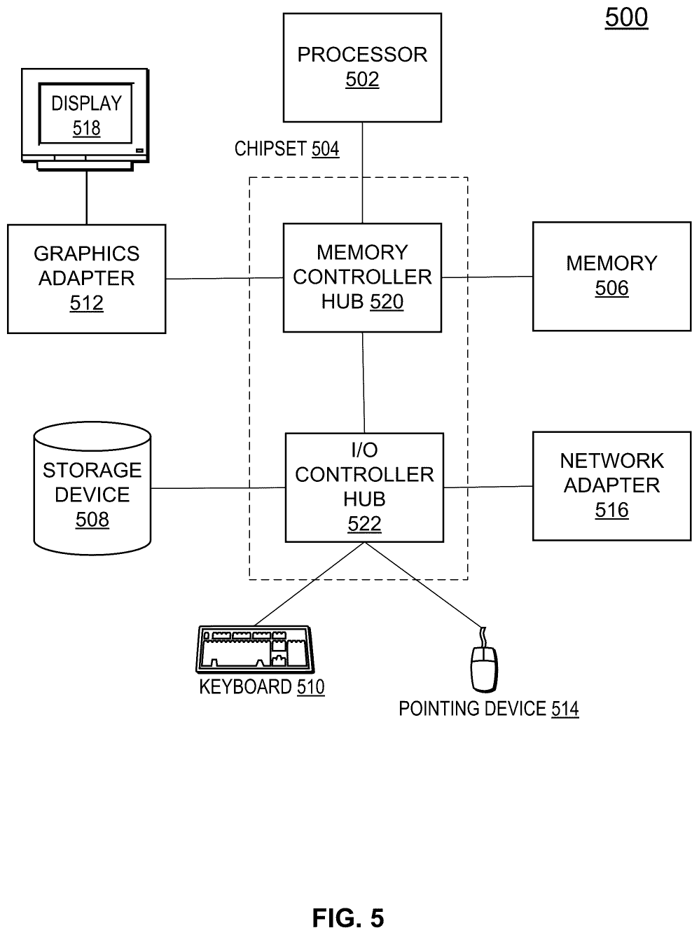

FIG. 5 is a high-level block diagram of a computer 500 for implementing different entities illustrated in FIG. 1. The computer 500 includes at least one processor 502 coupled to a chipset 504. Also coupled to the chipset 504 are a memory 506, a storage device 508, a keyboard 510, a graphics adapter 512, a pointing device 514, and a network adapter 516. A display 518 is coupled to the graphics adapter 512. In one embodiment, the functionality of the chipset 504 is provided by a memory controller hub 520 and an I/O controller hub 522. In another embodiment, the memory 506 is coupled directly to the processor 502 instead of the chipset 504.

The storage device 508 is any non-transitory computer-readable storage medium, such as a hard drive, compact disk read-only memory (CD-ROM), DVD, or a solid-state memory device. The memory 806 holds instructions and data used by the processor 502. The pointing device 514 may be a mouse, track ball, or other type of pointing device, and is used in combination with the keyboard 510 to input data into the computer 500. The graphics adapter 512 displays images and other information on the display 518. The network adapter 516 couples the computer 500 to the network 130.

As is known in the art, a computer 500 can have different and/or other components than those shown in FIG. 5. In addition, the computer 500 can lack certain illustrated components. For example, the computer acting as the server 110 or execution system 120 can be formed of multiple blade servers linked together into one or more distributed systems and lack components such as keyboards and displays. Moreover, the storage device 508 can be local and/or remote from the computer 500 (such as embodied within a storage area network (SAN)).

As is known in the art, the computer 500 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 508, loaded into the memory 506, and executed by the processor 502.

### Alternative Embodiments

It is to be understood that the figures and descriptions of the present invention have been simplified to illustrate elements that are relevant for a clear understanding of the present invention, while eliminating, for the purpose of clarity, many other elements found in a typical system. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise. Upon reading this disclosure, those of skill in the art will appreciate still additional alternative structural and functional designs for a system and a process for generating reports based on instrumented software through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for debugging scripting language programs specified using a scripting programming language, the method comprising:
starting an abstract syntax tree (AST) based interpreter for executing scripting language programs;
starting an AST debugging process configured to debug scripting language programs executed using the AST based interpreter;
starting a bytecode-based runtime for executing scripting language programs;
starting a bytecode debugging process configured to debug scripting language programs using the bytecode-based runtime;
configuring a debugger interface for interacting with an AST debugging process and a bytecode debugging process, wherein the debugger interface comprises one or more of: a graphical user interface or an application programming interface;
receiving a scripting language program specified using the scripting programming language, the scripting language program comprising a first section compiled into an abstract syntax tree and a second section compiled into bytecode;
receiving, via the debugger interface, a first set of one or more debug commands for debugging the first section of the scripting language program using the AST debugging process;
sending a first set of debug information obtained from the AST debugging process to the debugger interface;
receiving, via the debugger interface, debug instructions to continue debugging into the second section of the scripting language program;
switching debugging of the scripting language program from the AST debugging process to the bytecode debugging process; and
sending a second set of debug information obtained from the bytecode debugging process to the debugger interface.

2. The method of claim 1, further comprising:
responsive to switching debugging of the scripting language program to the bytecode debugging process, further receiving, via the debugger interface, a second set of one or more debug commands for debugging the first section of the scripting language program using the AST debugging process;
switching debugging of the scripting language program from the bytecode debugging process back to the AST debugging process; and
sending a third set of debug information obtained from the AST debugging process to the debugger interface.

3. The method of claim 1, wherein the first set of debug information comprises one or more of:
information identifying a line of the scripting language program that is currently executing;
one or more variables of the scripting language program; and
values of the one or more variables when the line of the scripting language program that is currently executing.

4. The method of claim 1, further comprising:
performing state synchronization between the AST debugging process and the bytecode debugging process using a publish subscribe mechanism to broadcast a status of execution from each of the AST debugging process or the bytecode debugging process to the other of the AST debugging process or the bytecode debugging process.

5. The method of claim 4, wherein the status of execution comprises information identifying a line of the scripting language program that is currently executing.

6. The method of claim 4, wherein responsive to the AST debugging process executing the first section of the scripting language program:
publishing the status of execution by the AST debugging process; and
receiving by the bytecode debugging process, the status of execution of the scripting language program from the AST debugging process.

7. The method of claim 4, wherein responsive to the bytecode debugging process executing the second section of the scripting language program:
publishing the status of execution by the bytecode debugging process; and
receiving by the AST debugging process, the status of execution of the scripting language program from the bytecode debugging process.

8. The method of claim 1, wherein the debugger interface receives a debug instruction and displays a status of execution of the scripting language program responsive to receiving the debug instruction, independent of whether the status of execution is received from the AST debugging process or from the bytecode debugging process.

9. A method for debugging scripting language programs specified using a scripting programming language, the method comprising:
configuring a debugger interface for interacting with a first debugging process and a second debugging process, wherein the first debugging process is configured to debug scripting language programs using a first execution engine and the second debugging process is configured to debug scripting language programs using a second execution engine;
receiving a scripting language program specified using the scripting programming language, the scripting language program comprising a first section and a second section, wherein the first section is configured to be executed using the first execution engine and the second section is configured to be executed using the second execution engine;
receiving, via the debugger interface, one or more debug commands for debugging the first section of the scripting language program;
receiving, from the first debugging process at the debugger interface, a first set of debug information;
receiving, by the debugger interface from the first debugging process, a first set of debug instructions to continue debugging into the second section of the scripting language program;
switching debugging of the scripting language program from the first debugging process to the second debugging process; and
receiving, by the debugger interface from the second debugging process, a second set of debug information.

10. The method of claim 9, wherein the first execution engine is an abstract tree syntax interpreter and the second execution engine is a bytecode interpreter.

11. The method of claim 9, wherein the first execution engine is a bytecode interpreter and the second execution engine is an abstract tree syntax interpreter.

12. The method of claim 9, further comprising:
responsive to switching debugging of the scripting language program to the second debugging process, further receiving, via the debugger interface, a third set of debug instructions for debugging the first section of the scripting language program using the first debugging process;
switching debugging of the scripting language program from the second debugging process back to the first debugging process; and
receiving, by the debugger interface from the first debugging process, a third set of debug information.

13. The method of claim 9, wherein the first set of debug information comprises one or more of:
information identifying a line of the scripting language program that is currently executing;
one or more variables of the scripting language program; and
values of the one or more variables when the line of the scripting language program that is currently executing.

14. The method of claim 9, further comprising:
performing state synchronization between the first debugging process and the second debugging process using a publish subscribe mechanism to broadcast a status of execution from each of the first debugging process or the second debugging process to the other of the first debugging process or the second debugging process.

15. The method of claim 14, wherein the status of execution comprises information identifying a line of the scripting language program that is currently executing.

16. The method of claim 14, wherein responsive to the first debugging process executing the first section of the scripting language program:
publishing the status of execution by the first debugging process; and
receiving by the second debugging process, the status of execution of the scripting language program from the first debugging process.

17. The method of claim 14, wherein responsive to the second debugging process executing the second section of the scripting language program:
publishing the status of execution by the second debugging process; and
receiving by the first debugging process, the status of execution of the scripting language program from the second debugging process.

18. The method of claim 9, wherein the debugger interface receives a debug instruction and displays a status of execution of the scripting language program responsive to receiving the debug instruction, independent of whether the status of execution is received from the first debugging process or from the second debugging process.

19. A method for managing execution of a scripting programming language using a plurality of execution engines, the method comprising:
starting a first execution engine for executing a first section of a program specified using a scripting programming language;
starting a second execution engine for executing a second section of a program specified using the scripting programming language;
starting execution of the scripting language program using the first execution engine;
during execution of the scripting language program using the first execution engine, switching execution of the scripting language program to the second execution engine;
switching execution of the scripting language program back to the first execution engine;
receiving a first set of one or more debug commands for debugging one of the first section or the second section of the scripting language program; and
sending a first set of debug information obtained from the first execution engine to the debugger interface.

20. The method of claim 19. wherein the first execution engine is an abstract tree syntax interpreter and the second execution engine is a bytecode interpreter.
